(19) United States
(12) Patent Application Publication
(10) Pub. No.: US 2009/0299670 A1
(43) Pub. Date: Dec. 3, 2009

(54) PROCESS CONTROL DEVICE AND PROCESS CONTROL METHOD

(75) Inventors: Toshiya Hirai, Kanagawa (JP); Minkyu Sohn, Kumamoto (JP)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: Sony Corporation, Tokyo (JP)

(21) Appl. No.: 12/476,643

(22) Filed: Jun. 2, 2009

(30) Foreign Application Priority Data
Jun. 3, 2008 (JP) 2008-146305

(51) Int. Cl. G06F 19/00

(52) U.S. Cl. 702/84

(57) ABSTRACT

A process control device includes: a determination unit reading device data generated by sensors provided at a process device and determining whether the process device is in a normal state or not; a correction value calculation unit calculating a correction value of a recipe by using measurement data generated by a measuring device provided at a succeeding stage of the process device and the device data when the determination unit determines that the process device is in the normal state, and calculating a correction value of the recipe by using the measurement data when the determination unit determines that the process device is not in the normal state; and a recipe correction unit correcting the recipe to be supplied to the process device based on the correction value outputted by the correction value calculation unit and transmitting the recipe to the process device.

### BACKGROUND OF THE INVENTION

1. Field of the Invention

The present invention relates to a technology which is suitable to be applied to a process control device and a process control method. More particularly, the invention relates to a technology of correcting a recipe given to a process device.

2. Description of the Related Art

In recent years, a demand for high-density integration of a semiconductor integrated circuit is increasing. As a pattern of the integrated circuit formed on a semiconductor wafer is miniaturized, it becomes more difficult to maintain the quality thereof. Accordingly, in order to meet the market demand, quality management in a semiconductor wafer processing process becomes more difficult.

### SUMMARY OF THE INVENTION

The fundamental flow of semiconductor manufacturing will be as follows:

(1) First, process processing with respect to a semiconductor wafer by a process device is performed.

(2) Next, measuring processing with respect to the result of process processing formed on the semiconductor wafer by a measuring device is performed.

(3) Then, the measurement result is transmitted to a process control device.

(4) The process control device performs fine adjustment of a recipe based on the received measurement result.

(5) Then, the adjusted recipe is transmitted to the process device to be used for process processing of a next semiconductor wafer.

Here, the process device is a kind of robot. The recipe is data instructing a procedure (sequence) of operations by the process device in detail, which is data instructing operation timing of a target to be controlled or maintenance of a given state with respect to the process device (robot).

However, the process device easily becomes worse due to disturbance because of miniaturization of semiconductor processing. That is, not only effects by slight variations of temperature, humidity and the like but also effects by deterioration in various components and so on which occurs during operation of the process device become prominent. Accordingly, it is necessary to increase the frequency of maintenance works as compared with the past, which reduces productivity of the whole system of semiconductor manufacturing.

Thus, it is desirable to provide a process control device and a process control method which is more tolerant with respect to disturbance and can reduce maintenance frequency as compared with related art.

In a process control device according to an embodiment of the invention, first, a determination unit reads device data generated by sensors provided at a process device and determines whether the process device is in a normal state or not.

When the determination unit determines that the process device is in the normal state, a correction value calculation unit calculates a correction value of a recipe by using measurement data generated by a measurement device provided at a succeeding stage of the process device and the device data.

When the determination unit determines that the process device is not in the normal state, the correction value calculation unit calculates a correction value of the recipe by using only the measurement data.

Then, the recipe correction unit corrects the recipe to be supplied to the process device based on the correction value outputted by the correction value calculation unit and transmits the recipe to the process device.

The device data figuring out the normal state of the process device is added to the parameter of the approximate expression for correcting the recipe. However, it is only used when the process device is in the normal state.

According to the embodiment of the invention, it is possible to provide a process control device and a process control method which is tolerant of disturbance and can reduce the maintenance frequency as compared with related art.

### BRIEF DESCRIPTION OF THE DRAWINGS

FIG. 1 is a schematic diagram of a semiconductor manufacturing system according to an embodiment of the invention;

FIG. 2 is a schematic diagram of the semiconductor manufacturing system;

FIG. 3 is a functional block diagram showing a process control device;

FIG. 4 is a view showing fields of respective tables;

FIG. 5 is a functional block diagram of a preparatory processing unit;

FIG. 6 is a functional block diagram of a determination unit;

FIG. 7 is a functional block diagram of a correction value calculation unit; and

FIG. 8 is a flowchart showing the flow of calculation of device data performed in a multivariate analysis calculation unit in the preparatory processing unit;

FIG. 9 is a flowchart showing the flow of creating approximate expressions performed in a first approximate expression creation unit and a second approximate expression creation unit in the preparatory processing unit;

FIG. 10 is a flowchart showing the flow of operations of the process control device when the semiconductor manufacturing system is in operation;

FIG. 11 is a graph showing an example of the second approximate expression; and

FIG. 12 is a graph showing an example of the first approximate expression.

### DESCRIPTION OF THE PREFERRED EMBODIMENTS

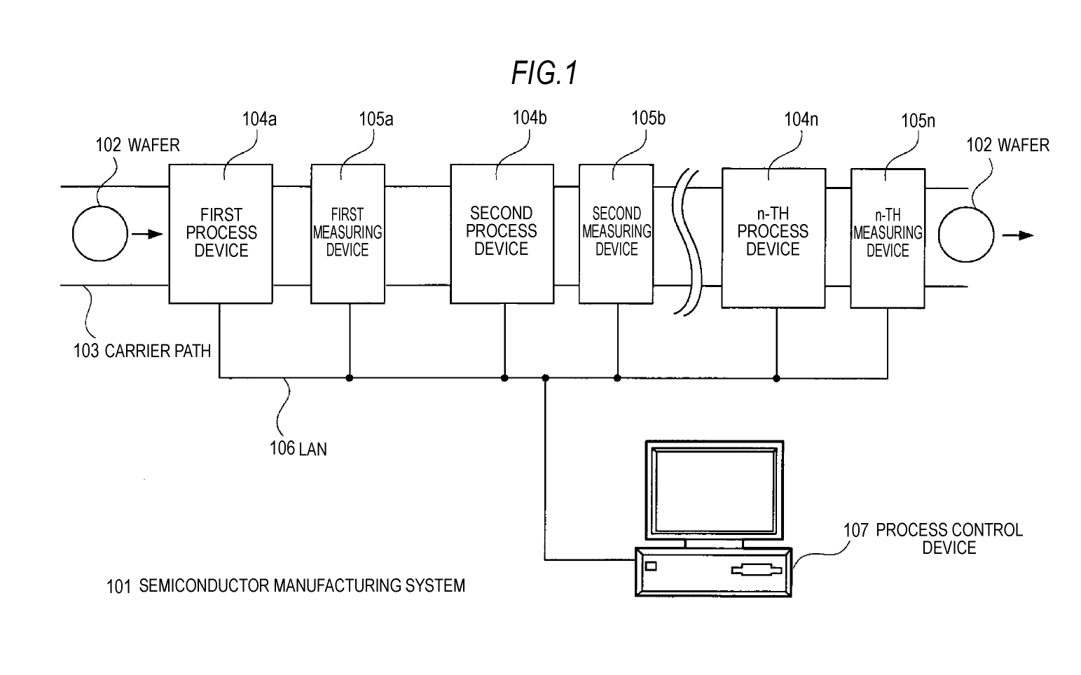

Hereinafter, embodiments of the invention will be explained with reference to FIG. 1 to FIG. 12.

FIG. 1 is a schematic diagram of a semiconductor manufacturing system according to an embodiment of the invention.

In a semiconductor manufacturing system 101, a semiconductor wafer 102 is put on a carrier path 103 and moved. When the semiconductor wafer 102 reaches a first process device 104a, a second process device 104b . . . and an n-th process device 104n, the wafer receives various processing by these process devices. After the processing by the process devices, prescribed measurements (examinations) are performed by a first measuring device 105a, a second measuring device 105b . . . and an n-th measuring device 105n. FIG. 1 shows a state in which plural process devices and measuring devices are respectively provided on the carrier path 103.

A LAN 106 is connected to respective process devices including the first process device 104a, the second process device 104b . . . and the n-th process device 104n and respective measuring devices including the first measuring device 105a, the second measuring device 105b . . . and the n-th measuring device 105n. A process control device 107 is also connected to the LAN 106.

The process control device 107 is a computer prepared for industrial applications and the substance thereof is substantially the same as a well-known personal computer.

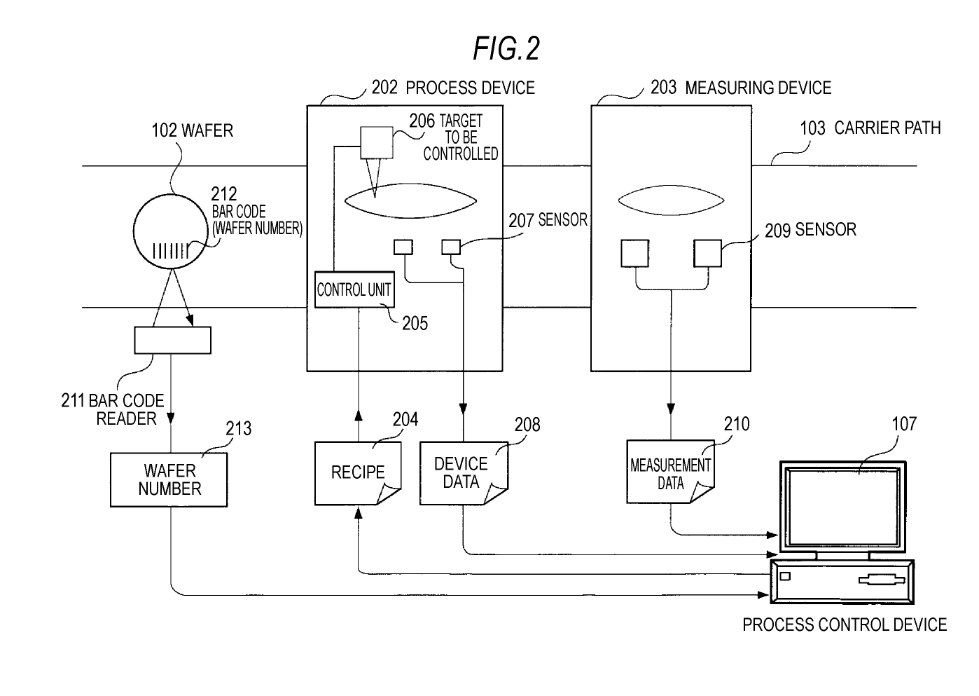

FIG. 2 is a schematic diagram of the semiconductor manufacturing system 101.

The semiconductor manufacturing system 101 performs plural processes to the semiconductor wafer 102, however, when seeing each process device 202 and a measuring device 203, processes can be regarded as respective independent processes.

The process device 202 is a kind of robot, receiving data called as a recipe 204 which instructs a procedure (sequence) of operations in detail and performing given processing to the semiconductor wafer 102. The data written in the recipe 204 is interpreted by a control unit 205 in the process device 202, appropriately performing drive control of a target to be controlled 206.

In the process device 202, various sensors 207 acquiring results of control by the recipe 204 are included, and data generated by these sensors 207 is transmitted to the process control device 107 as device data 208. The device data 208 is transmitted in various manners according to kinds of the sensors 207, some data is transmitted in real time and some data is transmitted discretely at prescribed time intervals.

In the measuring device 203, sensors 209 which are different from the sensors 207 included in the process device 202 are provided, measuring whether the processing of the semiconductor wafer 102 by the process device 202 is performed in a normal state or not. The measured result will be transmitted to the process control device as measurement data 210.

In the vicinity of an entrance of the process device 202 on the carrier path 103, a bar code reader 211 is provided. The bar code reader 211 reads a bar code 212 added to the semiconductor wafer 102. The bar code 212 is a number not repeated (unique) added to the semiconductor wafer 102. The number is called as a wafer number 213. When the wafer number 213 is read by the bar code reader 211, the number is transmitted to the process control device 107.

Note that there is a method in which a bar code is added to a carrier in which 25 pieces of the semiconductor devices 102 are packed and read the bar code instead of adding the barcode to the semiconductor wafer 102 to detect a position of the semiconductor wafer 102 in the carrier and acquire a wafer ID. In either case, the process control device 107 obtains a means for uniquely identifying the semiconductor wafer 102 by using the bar code reader 211.

The process control device 107 analyzes the measurement data 210 obtained from the measuring device 203 and performs necessary fine adjustment to the recipe 204 at the time of processing a next semiconductor wafer 102, then, transmits the recipe 204 to the process device 202. That is, the process control device 107 sees the outcome and reflects it on the next process. The process control device 107 performs feedback to the process device 202 to realize quality of the process in the right range with respect to various variation factors such as climate conditions of temperature, humidity and the like and secular change of the process device 202 itself.

In the embodiment, not only feedback considering the measurement data 210 but also feedback considering device data 208 is realized. The process control device 107 collects device data 208 which is previous operation performance of the semiconductor manufacturing system 101 and figures out the normal state of the process device 202 by multivariate analysis. When the device data 208 is in the normal state, in addition to fine adjustment of the recipe 204 in accordance with the measurement data 210 which is used from the past, fine adjustment of the recipe 204 is performed, in which the device data 208 is added to the measurement data 210 as a parameter for adjustment. The details thereof will be described later.

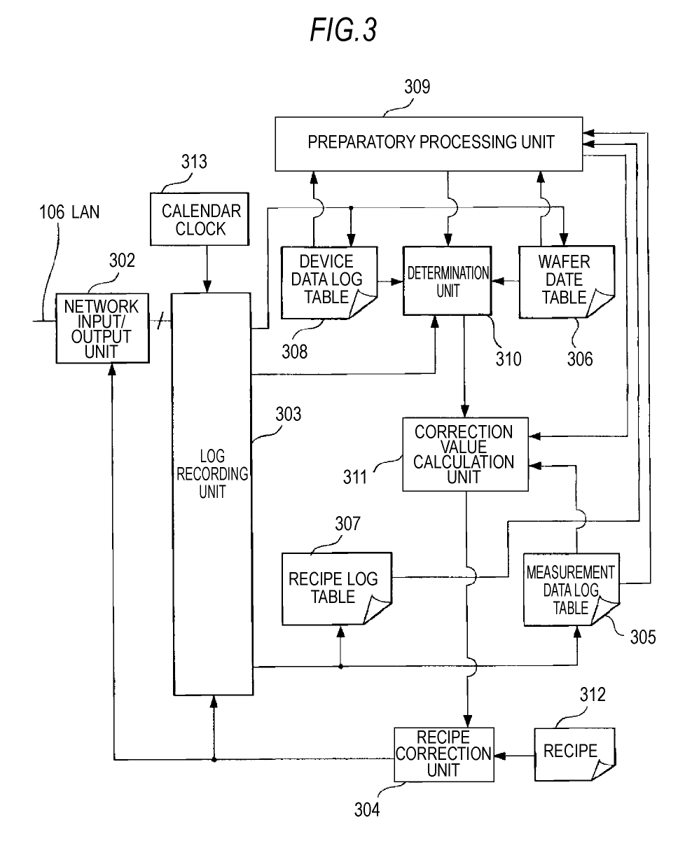

Functions of the process control device 107 will be explained with reference to FIG. 3 to FIG. 7 as follows.

FIG. 3 is a functional block diagram of the process control device 107.

The process control device 107 which is hardware approximately equivalent to a well-known personal computer realizes functions as the process control device by proscribed programs. Functional blocks shown in FIG. 3 are realized by programs.

A network input/output unit 302 receives the device data 208 outputted from the process device 202, the measurement data 210 outputted from the measuring device 203 and the wafer number 213 outputted from the bar code reader 211, outputting them to a log recording unit 303 as well as transmitting the corrected recipe outputted from a recipe correction unit 304 to the process device 202. The substance of the network input/output unit 302 is a network interface and a TCP/IP protocol stack.

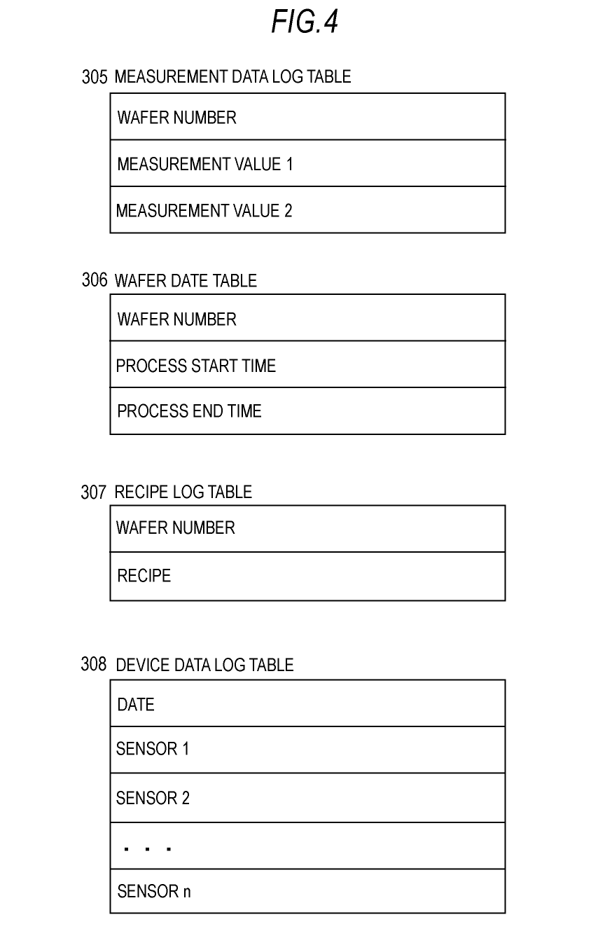

The log recording unit 303 records the device data 208, the measurement data 210 and the wafer number 213 obtained from the network input/output unit 302 and the corrected recipe obtained from the recipe correction unit 304 in respective tables. The contents, namely, fields to be recorded in respective tables will be explained with respect to FIG. 4 in the following description.

FIG. 4 is a view showing fields of respective tables.

In a measurement data log table 305, measurement values obtained from the measuring device 203 are recorded by being associated with the wafer number 213 by the log recording unit 303. The number of measurement values depends on the measuring device 203. In FIG. 4, a case in which there are two kinds of measurement values is shown.

Next, in a wafer date table 306, process start time and process end time are recorded by being associated with the wafer numbers 213 by the log recording unit 303. At this time, date data obtained from a calendar clock 313 connected to the log recording unit 303 is referred to.

As the process start time, a date when the wafer number 213 is obtained from the bar code reader 211 may be applied, or one of the sensors 207 in the process device 202 which can clearly recognize the process start may be used a trigger. Similarly, as the process end time, a date when the measurement data 210 is obtained from the measuring device 203 may be applied, or one of the sensors 207 in the process device 202 which can clearly recognize the process end may be used as a trigger. In either case, the wafer date table 306 is a table which associates the wafer number 213 with time when the semiconductor wafer 102 is processed by the process device 202.

In a recipe log table 307, the corrected recipe obtained from the recipe correction unit 304 is recorded by being associated with the wafer number 213.

In a device data log table 308, the device data 208 obtained from the process device 202 is recorded by being associated with a date. As described above, the device data 208 is an aggregation of data from many sensors. The data is transmitted in various manners according to kinds of the sensors 207, some data is transmitted in real time and some data is transmitted discretely at prescribed time intervals. The log recording unit 303 records values of respective sensors with the received dates in the device data log table 308.

The number of respective sensors included in the device data 208 is the number of sensors provided in the process device 202. Therefore, the number of sensors is increased or decreased according to kinds of the process device 202. In FIG. 4, it is assumed that there are n-pieces of sensors in a certain process device 202.

Returning to FIG. 3 and the explanation is continued.

A preparatory processing unit 309 reads the device data log table 308, the wafer date table 306 and the measurement data log table 305 and creates necessary data to be outputted to a determination unit 310 and a correction value calculation unit 311.

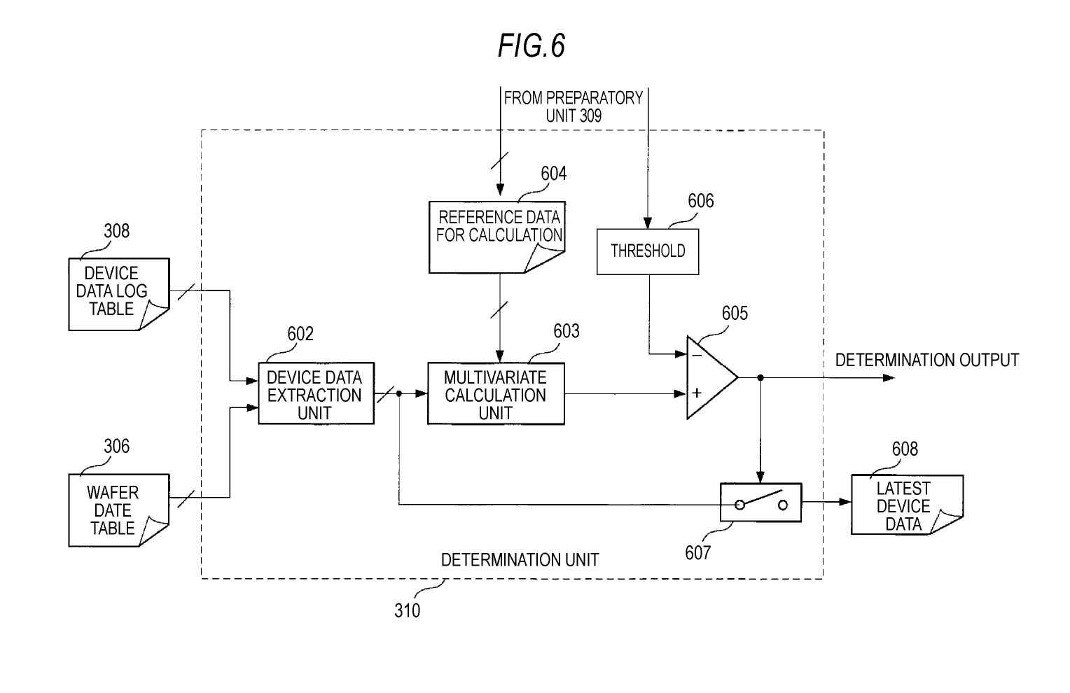

The determination unit 310 extracts the latest device data 608 (refer to FIG. 6) which will be described later from the device data log table 308 and the wafer date table 306 and performs prescribed calculation processing, then, determines whether the data exceeds a given threshold of not.

The correction value calculation unit 311 receives the determination result from the determination unit 310 and the latest device data 608, performing prescribed calculation processing to create recipe correction data.

The recipe correction unit 304 performs fine adjustment to a recipe 312 by using recipe correction data with respect to the recipe 204. This is the corrected recipe. After that, the recipe correction unit 304 outputs the created corrected recipe to the network input-output unit 302 and the log recording unit 303.

The operation of the process control unit 107 can be roughly divided into two.

One of them is processing by the preparatory processing unit 309 which makes preparation before actually operating the process device 202.

The other operation is processing by the determination unit 310, the correction value calculation unit 311 and the recipe correction unit 304 which are operated when the process device 202 is actually operated.

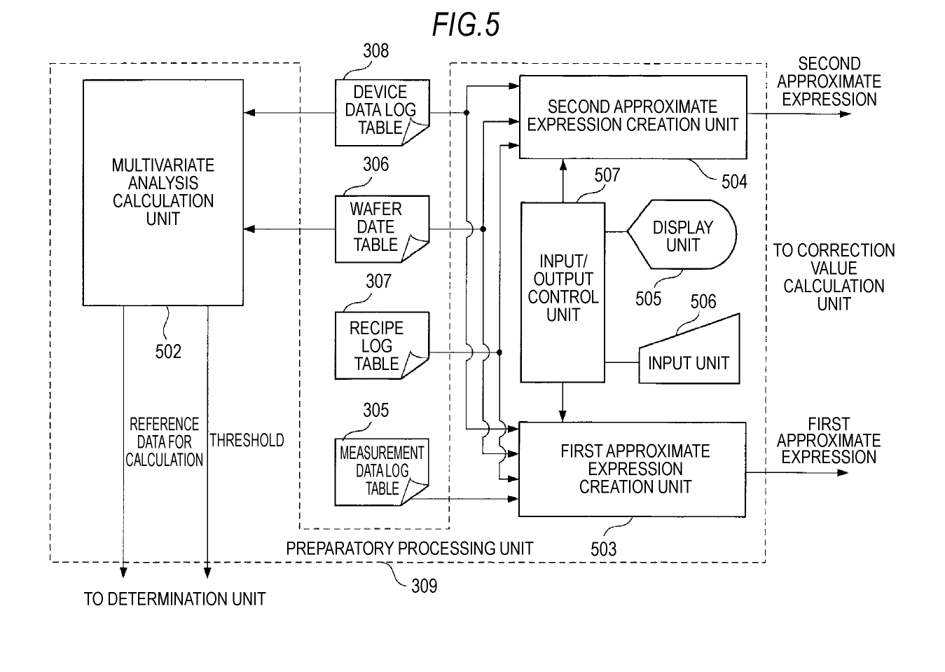

FIG. 5 is a functional block diagram of the preparatory processing unit 309.

The function of the preparatory processing unit 309 can be roughly divided into two functions.

A multivariate analysis calculation unit 502 reads the device data log table 308 and the wafer date table 306 and performs multivariate analysis calculation. Then, the multivariate analysis calculation unit 502 outputs reference data for calculation and a threshold which are necessary for the determination unit 310 to the determination unit 310.

A first approximate expression creation unit 503 reads the measurement data log table 305, the device data log table 308, the wafer date table 306 and the recipe log table 307 and creates a first approximate expression.

A second approximate expression creation unit 504 reads the device data log table 308, the wafer date table 306 and the recipe log table 307 and creates a second approximate expression.

The first approximate expression and the second approximate expression are expressions which express tendency of operations of the process device 202 approximately. As a method of creating the approximate expression, a well-known least square method is used.

It is necessary that the first approximate expression creation unit 503 selects the sensor (item) to be used for calculation from the device data log table 308. Therefore, a display unit 505 including a display, an input unit 506 such as a keyboard and an input/output unit 507 are connected.

The processing contents of the preparatory processing unit 309 are roughly divided into two processing.

One of them is processing which outputs reference data for calculation and a threshold to the determination unit 310.

The other of them is processing which outputs the first approximate expression and the second approximate expression to the correction value calculation unit 311.

The two processings are both executed before the process device 202 is actually operated.

FIG. 6 is a functional block diagram of the determination unit 310.

A device data extraction unit 602 acquires a process start time and a process end time of the latest wafer number 213 which are recorded in the latest record of in the wafer data table 306. The device 208 corresponding to the time slot is read from the device data log table 308.

A multivariate calculation unit 603 calculates a prescribed scalar value from the latest device data 608 outputted from the device data extraction unit 602 by using reference data for calculation 604 which has been previously acquired by the preparatory processing unit 309.

A comparison unit 605 compares the prescribed scalar value outputted from the multivariate calculation unit 603 with a threshold 606 which has been previously acquired from the preparatory processing unit 309 and outputting the comparison result of large or small. When the above scalar value is smaller than the threshold 606, a switch 607 is controlled to be on, and the latest device data 608 is outputted from the device data extraction unit 602 to the correction value calculation unit 311.

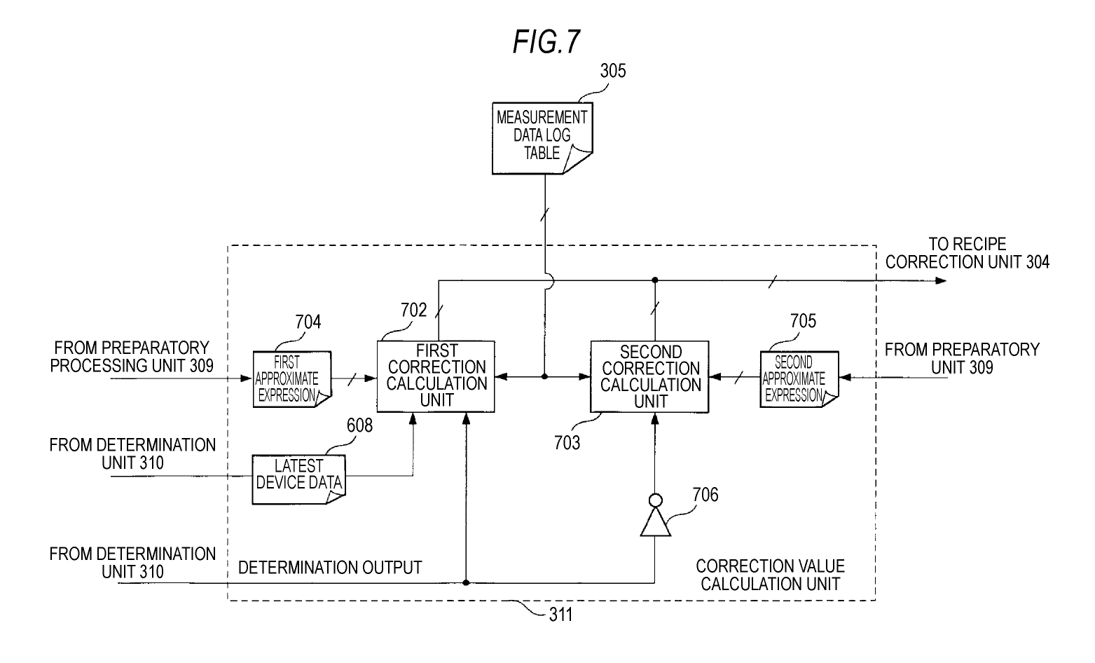

FIG. 7 is a functional block diagram of the correction value calculation unit 311.

The comparison result outputted from the determination unit 310 exclusively performs drive control of a first correction calculation unit 702 and a second correction calculation unit 703 as determination output. Therefore, the determination output supplied to the second correction calculation unit 703 from the determination unit 310 is logically inverted by a NOT gate 706.

The first correction calculation unit 702 acquires the latest measurement data 210 from the measurement data log table 305 as well as acquires the latest device data 608 outputted from the determination unit 310 and calculates a correction value of the recipe 312 by using the first approximate expression 704 obtained from the preparatory processing unit 309.

The second correction calculation unit 703 acquires the latest measurement data from the measurement data log table 305 and calculates a correction value of the recipe 312 by using the second approximate expression 705 previously obtained from the preparatory processing unit 309.

The correction values of the recipe outputted from the first correction calculation unit 702 and the second correction calculation unit 703 are supplied to the recipe correction unit 304.

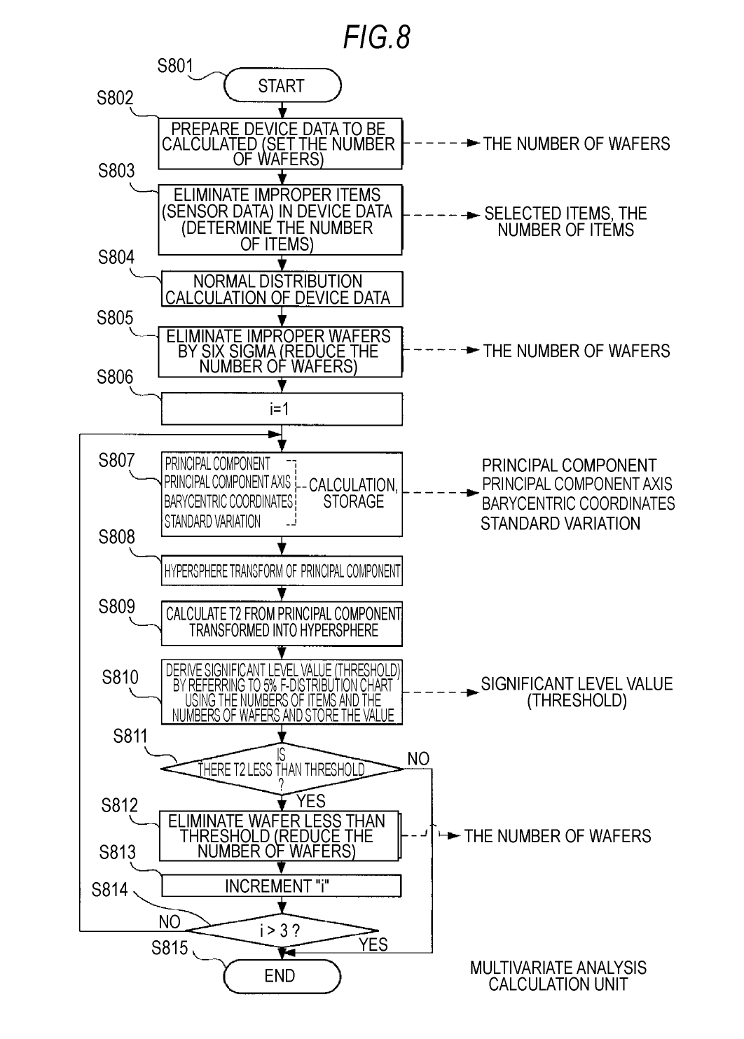

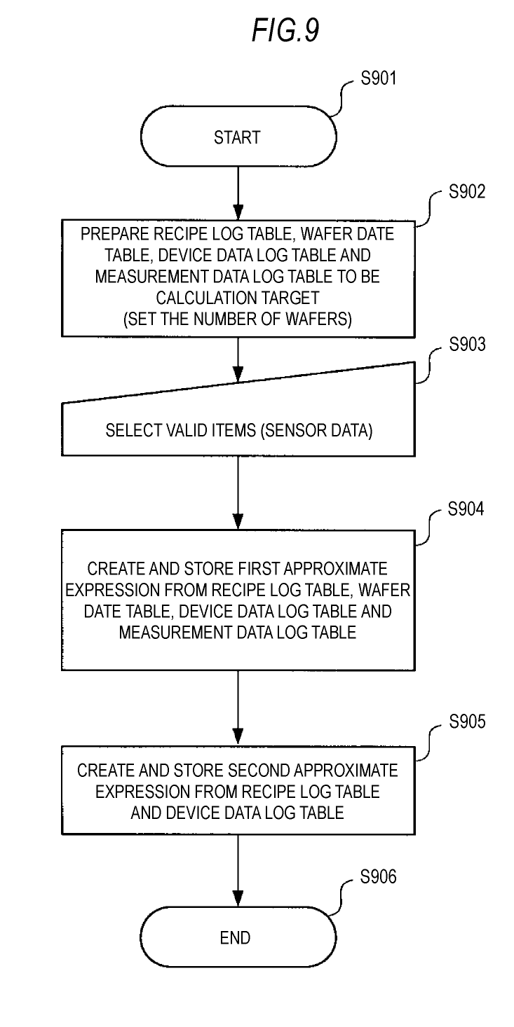

Processing performed in the preparatory processing unit 309 will be explained with reference to FIG. 8 and FIG. 9.

FIG. 8 is a flowchart showing the flow of calculation of device data performed in the multivariate analysis calculation unit 502 in the preparatory processing unit 309. This is well-known as multivariate analysis in the process control.

When the processing is started (S801), first, the multivariate analysis calculation unit 502 prepares device data of the prescribed number of records from the device data log table 308 and the wafer date table 306 (S802). Specifically, for example, when it is determined that the data of “50 pieces of wafers” is prepared, corresponding time information is acquired from the wafer data table 306 and corresponding device data is specified.

The specified device data includes data of plural sensors. There exists improper sensor data among them at the time of multivariate analysis. Specifically, sensor data which generates multicollinearity and sensor data which only outputs a fixed value are improper. Accordingly, such sensor data (items) is eliminated from the calculation target (S803).

The processing means that some sensors are thinned out from the field of many sensors existing in the device data which is one large table.

Next, normal distribution calculation is performed to the device data including items selected in Step S803 (S804). Then, records of improper semiconductor wafers 102 in the device data are eliminated by a method of Six Sigma (S805). That is, the data is statistically narrowed down to eliminate records deviated from the distribution including the most records.

The process after that will be loop processing.

First, a counter variable “i” is initialized to “1” (S806).

Next, a principal component, a principal component axis, barycentric coordinates and standard deviation are calculated from device data to be stored in a non-volatile storage which is now shown (S807). The principal component analysis is one of multivariate analysis methods, which is an analysis method of extracting a principal component explaining characteristics of the data from sample data.

Next, hypersphere transform is performed in order to normalize the calculated principal component (S808).

The hypersphere transform is processing in which standardization is performed by dividing each principal component by the standard deviation of the axial direction in the principal component analysis. The hypersphere indicates the aggregate of points within a certain distance from a certain point (center) which is called as a radius in n-dimensional space, which is natural expansion of a two-dimensional circle or a three-dimensional sphere. The points within a sphere having a radius “r” in which the origin is the center in the n-dimensional space satisfy an inequality (x(1)̂2+x(2)̂2+ . . . +x(n)̂2)<=r̂2. The points on the sphere satisfies an equation (x(1)̂2+x(2)̂2+ . . . +x(n)̂2)=r̂2.

Then, T² which is a feature amount as a scalar value is calculated from the principal component which received hypersphere transform (S809). The T² is particularly referred to as a Hotelling's T². The Hotelling's T² is an index for determining whether data which is different from sample data is deviated from reference space formed by sample data or not, which is the scalar value. According to the calculation processing, many existing sensor data is converted into a single scalar value.

Next, a significant level value is derived by referring to “5% F-distribution chart” using the number of items determined in Step S803 and the number of wafers narrowed down in Step S805. The “5% F-distribution chart” is a distribution chart in which the significant level is set to 5% in probability distribution of the F value (ratio of variance within groups and variance between groups) calculated by repeatedly extracting samples from the population in the normal distribution. The significant level value is a constant representing with what degree of accuracy is null hypothesis rejected, which indicates probability of rejecting the null hypothesis (type 1 error) when the null hypothesis is correct.

Then, the significant level value is stored in the non-volatile storage (S810). The significant level value is, when finally determined in later-described step S814, outputted to the determination unit 310 as the threshold 606.

Next, whether a T² less than the threshold 606 exists or not is checked by comparing T² in respective records which have been calculated with the significant level value (threshold 606) (S811). If there exists a T²value though only one T² (Y in S811), the target record is eliminated (S812). As a result, the number of wafers (the number of records) is reduced at this point. Then, the counter variable “i” is incremented (S813), and whether the counter variable “i” exceeds 3 or not is checked (S814). When the variable does not exceed 3 (N in S814), the same calculation processing is continued from Step S807 again. When the counter variable “i” exceeds 3 in Step S814, the calculation processing is stopped even when there exists T² less than the threshold 606, and the process ends (S815). When there is no T² less than the threshold 606 in Step S811 (N in S811), the process ends at that time (S815).

In Step S814, namely, at the end of the series of processing, the reference data for calculation 604 and the threshold 606 referred to by the determination unit 310 are determined.

The reference data for calculation 604 indicates the principal component axis, the barycentric coordinates and standard deviation.

The threshold 606 is the significant level value obtained in Step S810 finally executed.

These values are updated with the proceeding of the loop processing and determined at the end of loop processing.

FIG. 9 is a flowchart showing the flow of creating expressions performed in the first approximate expression creation unit 503 and the second approximate expression creation unit 504 in the preparatory processing unit 309.

When the processing is started (S901), first, an operator determines records to be calculation targets for the device data log table 308, the wafer date table 306, the recipe log table 307 and the measurement data log table 305 through the input/output control unit 507 by operating the input unit 506 while seeing the display unit 505 (S902). Then, the operator selects sensor data (item) to be determination targets at the fine adjustment of the recipe 312 from the device data log table 308 (S903). The selection is made based on experience of the operator, however, the same or more efficient result can be obtained when using a given statistical calculation.

When the determination of the item is performed by the operator, the first approximate expression creation unit 503 receives the determination, creating a first approximate expression 704 from the record to be a calculation target in the device data log table 308, the wafer date table 306, the recipe log table 307 and the measurement data log table 305 and storing the expression in a not-shown non-volatile storage (S904). Similarly, the second approximate expression creation unit 504 creates and stores a second approximate expression 705 from the record to be the calculation target in the recipe log table 307 and the device data log table 308 (S905), then, all the processings end (S906).

In Step S906, namely, at the end of the series of processing, the first approximate expression 704 and the second approximate expression 705 are transmitted to the correction value calculation unit 311.

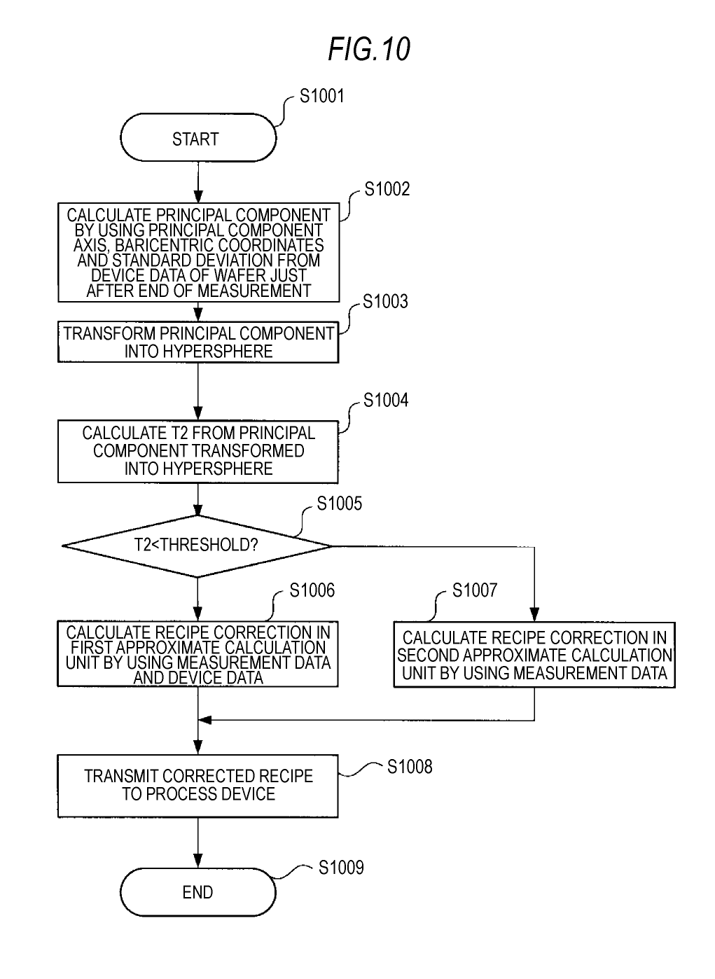

FIG. 10 is a flowchart showing the flow of operations of the process control device 107 when the semiconductor manufacturing system 101 is in operation.

When the measurement processing by the measuring device 203 ends, a series of processing is started (S1001).

The device data extraction unit 602 in the determination unit 310, when recognizing the end of measurement processing by the measuring device 203, extracts the latest device data 608 from the device data log table 308 and the wafer date table 306. The latest device data 608 is supplied to the multivariate calculation unit 603. The multivariate calculation unit 603 calculates the principal component by using the latest device data 608 and the reference data for calculation 604, specifically, the above-described principal component axis, the barycentric coordinates and the standard deviation (S1002).

Next, the multivariate calculation unit 603 transforms the principal component into a hypersphere (S1003) and calculates T² which is the scalar value from the principal component transformed into the hypersphere (S1004).

The T² is supplied to the comparison unit 605. To the other terminal of the comparison unit 605, the threshold 606 calculated by the preparatory processing unit 309, namely, the significant level value is given. The comparison unit 605 compares T² with the threshold 606 (S1005). As a result of comparison, when T²is less than the threshold 606 (Y in S1005), the determination output will be true. The determination output is supplied to the correction value calculation unit 311. The determination output is supplied to the switch 607, thereby the switch 607 is controlled to be on and the latest device data 608 is outputted to the correction value calculation unit 311.

The first correction calculation unit 702 operates by receiving the “true” as the determination output. Receiving the latest device data 608 and the latest record in the measurement data log table 305, the correction value of the recipe is calculated by using the first approximate expression 704 (S1006).

As the result of comparison in Step S1005, when T² is equal to or more than the threshold 606 (S1005), the determination output will be false. The determination result is supplied to the correction value calculation unit 311. The determination output is supplied to the switch 607, thereby the switch 607 is controlled to be off and the latest device data 608 is not outputted to the correction value calculation unit 311.

The second correction calculation unit 703 operates by receiving “false” as the determination output. Receiving the latest record in the measurement data log table 305, the recipe correction value is calculated by using the second approximate expression 705 (S1007).

In either case, the recipe correction value is supplied to the recipe correction unit 304 and fine adjustment of the recipe 204 is performed, then, the correction value is transmitted to the process device 202 (S1008) and the series of processing ends (S1009).

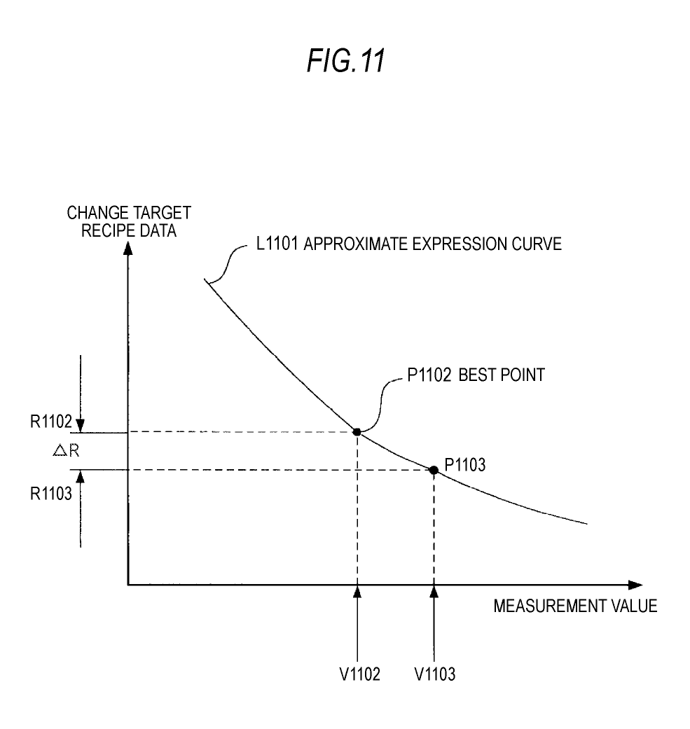

FIG. 11 is a graph showing an example of the second approximate expression.

In order to simplify the explanation, it is assumed that the measurement value is one and fine-adjustment target recipe data is one in FIG. 11.

Assume that it is the best value when the measurement value is V1102 on the graph. The fine-adjustment target recipe data corresponding to V1102 is R1102 from the best point P1102 on an approximate expression curve L1101.

Now, as a result of measurement of a certain wafer, assume that the measurement value is V1103. Then, the corresponding point on the approximate expression curve L1102 is P1103, and corresponding fine-adjustment target recipe data is R1103. Accordingly, when a next wafer is processed, processing of adding the difference between R1103 and R1102 to the fine-adjustment target recipe data is performed in order to allow the measurement value to be close to V1102 from V1103.

This is the processing of the second correction calculation unit 703 in FIG. 7, which corresponds to Step S1007 of FIG. 10.

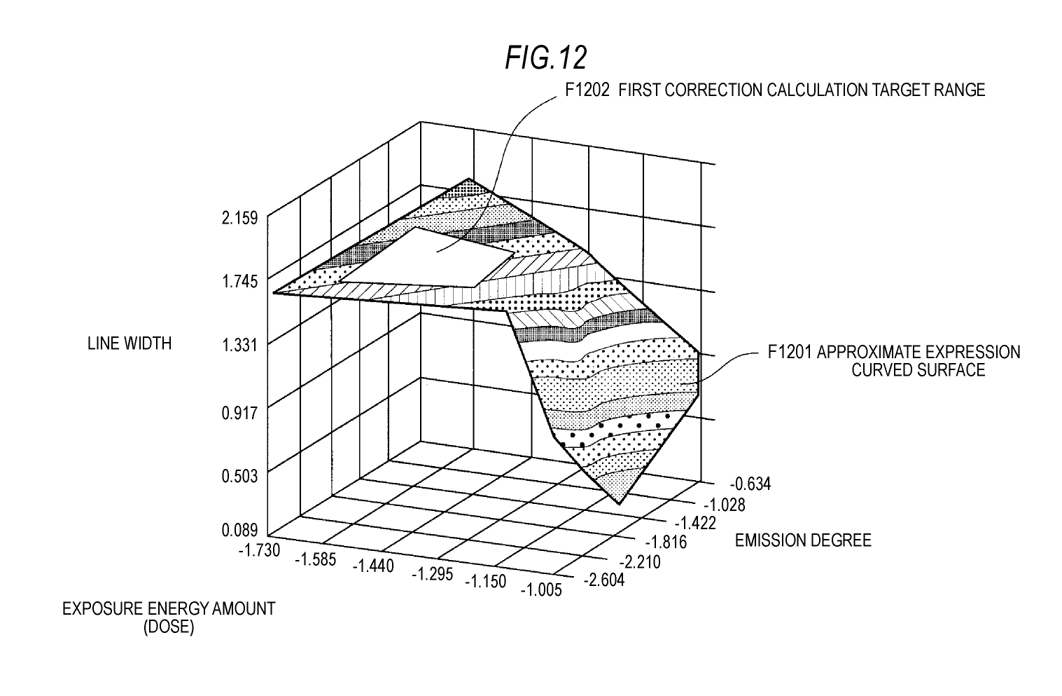

FIG. 12 is a graph showing an example of the first approximate expression.

In order to simplify the explanation, it is assumed that the measurement value (line width) is one, fine-adjustment recipe data (exposure energy amount) is one and the device data to be observed (emission degree) is also one.

FIG. 11 is the two-dimensional graph because parameters are two, however, FIG. 12 is a three-dimensional graph because parameters are three. The approximate expression curve L1101 of FIG. 11 corresponds to an approximate expression curved surface F1201 in FIG. 12. However, the approximate curved surface F1201 is calculated by including data when the state of the process device is not normal. The range when the state of the process device is normal in the approximate expression curved surface F1201, that is, the curved surface when the device data is within a normal range is a first correction calculation target range F1202.

The barycenter existing on the first correction calculation target range F1202 is the barycenter calculated by the multivariate analysis calculation unit 502 of FIG. 5 in Step S807 of FIG. 8.

The first correction calculation unit 702 of FIG. 7 calculates the recipe correction value so that the measurement value is closed to the barycenter in Step S1006 of FIG. 10.

There exists a process device which deteriorates as time passes in individual components included in the process device itself. Therefore, it is difficult maintain fixed quality concerning process processing with respect to the semiconductor wafer only by operating the process device just in a uniform state.

In the embodiment, technical thought that “deterioration over time of the process device is compensated by correction of the recipe” is applied to the process control device. In order to realize the technical thought, not only measurement data but also device data are added to approximate expressions for the recipe correction as elements.

However, it is difficult to fully apply the technical thought in process control. Because when the state of the process device is not normal, the device data itself adversely affects the recipe correction. In the embodiment, “recipe correction by using the approximate expression to which the device data is added” is performed only when the device data is within the normal range, namely, only when the process device is in the normal state.

In the embodiment, the following applications can be considered.
(1) The multivariate analysis performed by the multivariate analysis calculation unit 502 and the multivariate calculation unit 603 is not limited to the contents of FIG. 8 and FIG. 10. A common algorithm of multivariate analysis in which the multivariate is transformed into a given scalar value by performing statistical processing and the scalar value is compared with a given threshold to determine normal/abnormal can be used as it is. Many algorithms can be cited, for example, multiple linear regression analysis, Mahalanobis' distance and the like.

In the embodiment, the semiconductor manufacturing system, particularly, the technical contents of the process control device which plays the central role in the system are disclosed.

In addition to the correction of the recipe based on measurement data which has been performed in related art, the function of performing correction of the recipe based on measurement data and device data when detecting that the device data is in the normal state is added.

By adding the recipe correction function, it is possible not only to aim at the processing state of the semiconductor wafer to the best condition but also to realize process control which can suppress adverse effects due to deterioration over time in the process device.

According to the above, it is possible to anticipate that an effect of maintaining wafer quality in the best condition as compared with the past, which contributes to the improvement of yield.

It is also possible to anticipate that the frequency of maintenance work performed for maintaining the normality of the process device is reduced. That is to say, the frequency of maintenance work performed by temporarily stopping the operation of the process device is reduced, which contributes to the improvement of productivity of the whole semiconductor manufacturing system.

As described above, the embodiment of the invention have been explained, however, the invention is not limited to the above embodiment and it goes without saying that other modification examples and applications are included insofar as they are within the scope of the appended claims.

The present application contains subject matter related to that disclosed in Japanese Priority Patent Application JP filed in the Japan Patent Office on Jun. 3, 2008, the entire contents of which is hereby incorporated by reference.

What is claimed is:

1. A process control device comprising:
a determination unit reading device data generated by sensors provided at a process device and determining whether the process device is in a normal state or not;
a correction value calculation unit calculating a correction value of a recipe by using measurement data generated by a measuring device provided at a succeeding stage of the process device and the device data when the determination unit determines that the process device is in the normal state, and calculating a correction value of the recipe by using the measurement data when the determination unit determines that the process device is not in the normal state; and
a recipe correction unit correcting the recipe to be supplied to the process device based on the correction value outputted by the correction value calculation unit and transmitting the recipe to the process device.

2. The process control device according to claim 1, further comprising:
a log recording unit recording the device data, the measurement data and the recipe in a device data log table, a measurement data log table and a recipe log table;
a multivariate analysis calculation unit reading the device data log table and calculating reference data for calculation and a threshold used by the determination unit;
a first approximate expression creation unit reading the device data log table, the measurement data log table and the recipe log table and calculating the a first approximate expression used by the correction value calculation unit when the determination unit determines that the process device is in the normal state; and
a second approximate expression creation unit reading the device data log table and the recipe log table and calculating a second approximate expression used by the correction value calculation unit when the determination unit determines that the process device is not in the normal state.

3. A process control method comprising the steps of:
calculating reference data for calculation and a threshold for determining a normal state of a process device by multivariate calculation from a device data log table in which device data generated from sensors previously provided at the process device is accumulated in advance of process processing;
creating a first approximate expression for correcting a recipe when the process device is in the normal state by reading a measurement data log table in which measurement data generated by a measuring device previously provided at a succeeding stage of the process device is accumulated, a recipe log table in which recipes to be supplied to the process device are accumulated and the device data log table in advance of the process processing;
creating a second approximate expression for correcting the recipe when the process device is not in the normal state by previously reading the recipe log table and the device data log table in advance of the process processing;
determining whether the process device is in the normal state or not by performing calculation processing by using the device data obtained from the process device according to the result of the process processing, reference data for calculation and the threshold;
calculating a correction value of the recipe by using the first approximate expression when the process device is in the normal state and calculating a correction value of the recipe by using the second approximate expression when the process device is not in the normal state based on the result of the step of determination; and
correcting the recipe by using the correction value and transmitting the recipe to the process device.
